(19) United States
(12) Patent Application Publication
(10) Pub. No.: US 2025/0351769 A1
(43) Pub. Date: Nov. 20, 2025

(54) SELF-PROPELLED FRONT NUTRIENT SPREADING VEHICLE

(71) Applicant: Mensch Manufacturing, L.L.C., Hastings, MI (US)

(72) Inventors: Noah Mensch, Hastings, MI (US); Donald Mensch, Hastings, MI (US)

(21) Appl. No.: 18/664,727

(22) Filed: May 15, 2024

(51) Int. Cl. A01C 15/18; A01C 17/00; A01C 21/00

(52) U.S. Cl. CPC A01C 15/18; A01C 17/001; A01C 17/006; A01C 21/00

(57) ABSTRACT

The present disclosure provides a large-scale, self-propelled nutrient spreading vehicle for efficient and precise nutrient distribution. The nutrient spreading vehicle features a drive chassis supporting an engine, wheels, and a transmission, enabling self-propelled movement. A nutrient hopper stores nutrients, while a front-mounted spreader, controlled through an in-cabin user interface, allows for adjustable discharge of the nutrients. The vehicle's conveyor system transports the nutrients from the hopper under the vehicle cabin to the front-mounted spreader. The vehicle cabin is mounted above the conveyor system, providing operators with an unobstructed view of the nutrient discharge process, thereby enhancing control and precision. Additionally, the nutrient spreading vehicle accommodates interchangeable nutrient spreaders. Control systems with adjustable parameters allow dynamic adjustment of nutrient transport and spread characteristics.

### BACKGROUND OF THE INVENTION

The present invention relates to agricultural equipment, more specifically to large-scale self-propelled nutrient spreaders that address and mitigate the limitations and problems associated with traditional methods of nutrient application, particularly those utilizing rear distribution.

In modern agriculture, the efficient and precise application of nutrients to crops generally involves increasing yield and ensuring the sustainability of farming practices. Traditionally, nutrient spreaders, particularly those designed for large-scale agricultural applications, have employed rear-spreading mechanisms usually pulled by a tractor or trailer. While these traditional designs are prevalent and have advanced agricultural productivity, they are not without significant drawbacks that can affect both the efficiency and accuracy of nutrient application.

One of the primary issues with rear nutrient spreaders is the visibility of the nutrient distribution. Because the spreading is done out the rear, the operator's visibility and control over the spreading process are often limited, which can lead to uneven nutrient distribution or in some cases the operator not realizing the nutrients are jammed and not being distributed at all.

Another significant problem associated with rear nutrient spreading is the difficulty in accessing tight or irregularly shaped fields. The design of rear spreaders often requires wide, open areas for effective operation, limiting their usefulness in fields with obstacles or unconventional layouts.

For at least these reasons, there is a pressing need for innovations in nutrient spreading technology that address these challenges.

### SUMMARY OF THE INVENTION

The present disclosure introduces a self-propelled large-scale nutrient spreader. The vehicle cabin is disposed above a conveyor system that extends from the nutrient hopper, facilitating a direct line of sight to the nutrient distribution process and enhancing control and precision in nutrient application.

The cabin being mounted above the front conveyor, e.g., centrally mounted, allows operators to monitor the flow of nutrients from a vantage point that was previously unattainable with traditional rear distribution systems.

The conveyor system efficiently transports nutrients to the front mounted spreader, ensuring a steady and controlled flow. Various parameters of the conveyor system can be adjusted in memory to provide precise tuning of the rate of nutrient application. This operational tuning can be done dynamically and automatically via a conveyor control system to accommodate specific or changing vehicle speeds, spreader speeds, different spreader attachments, field conditions, and crop needs.

The cabin and integrated conveyor system provides more effective and accurate nutrient application strategies for modern farming operations. These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 is a perspective view of a self-propelled front discharge nutrient spreading vehicle with a center-mounted cab.

FIG. 2 is an exploded view of the self-propelled front discharge nutrient spreading vehicle of FIG. 1.

FIG. 3 is a top view of the self-propelled front discharge nutrient spreading vehicle of FIG. 1.

FIG. 4 is a sectional side view of the self-propelled front discharge nutrient spreading vehicle of FIG. 1.

FIG. 5 is a perspective view of another embodiment of a self-propelled front discharge nutrient spreading vehicle with a center-mounted cab.

FIG. 6 is an exploded view of the self-propelled front discharge nutrient spreading vehicle of FIG. 5.

FIG. 7 is a top view of the self-propelled front discharge nutrient spreading vehicle of FIG. 5.

FIG. 8 is a sectional side view of the self-propelled front discharge nutrient spreading vehicle of FIG. 5.

### DETAILED DESCRIPTION OF THE CURRENT EMBODIMENTS

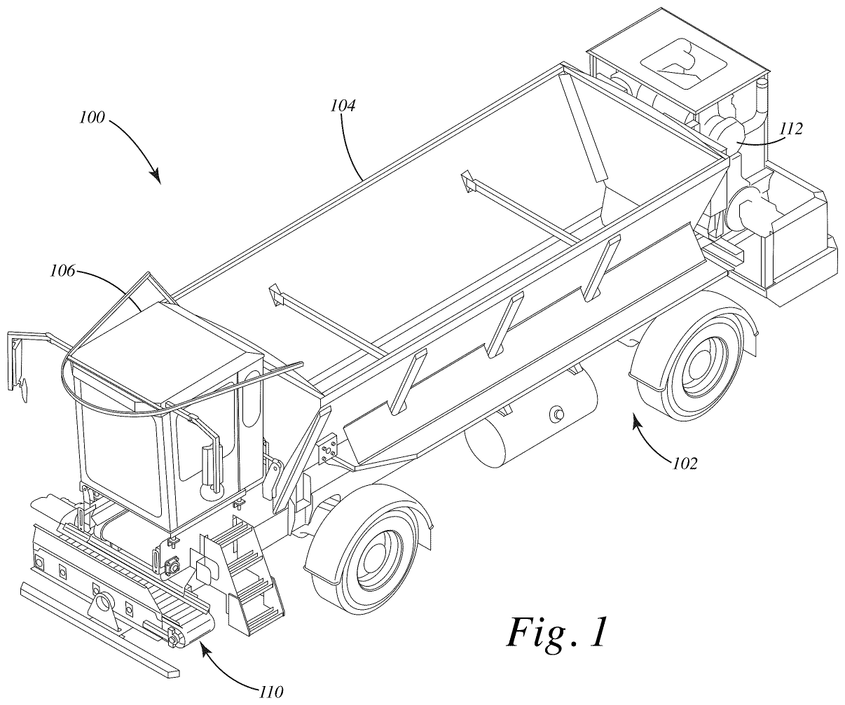

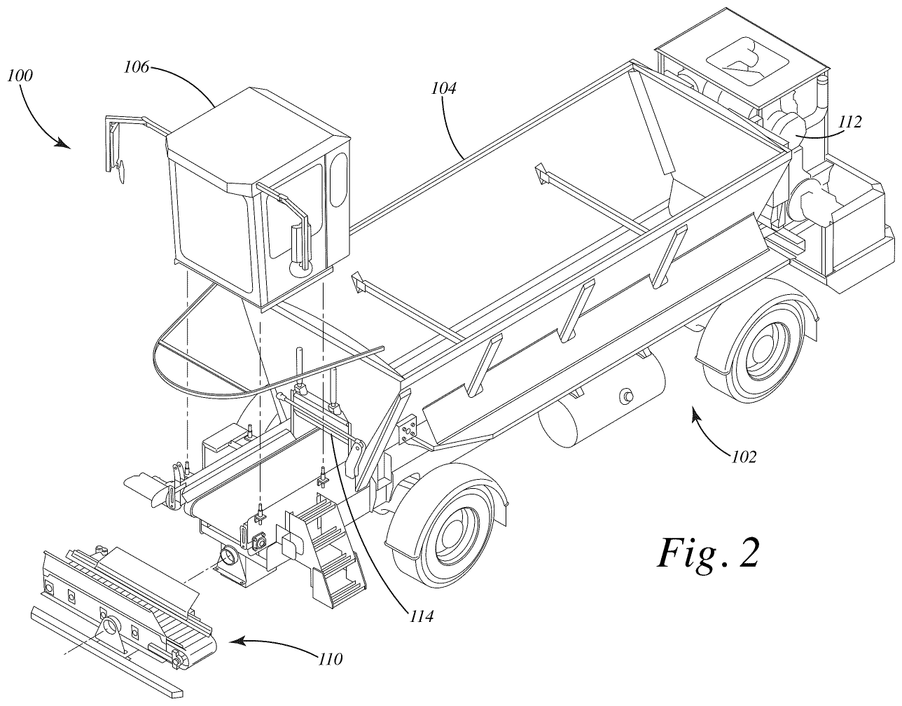

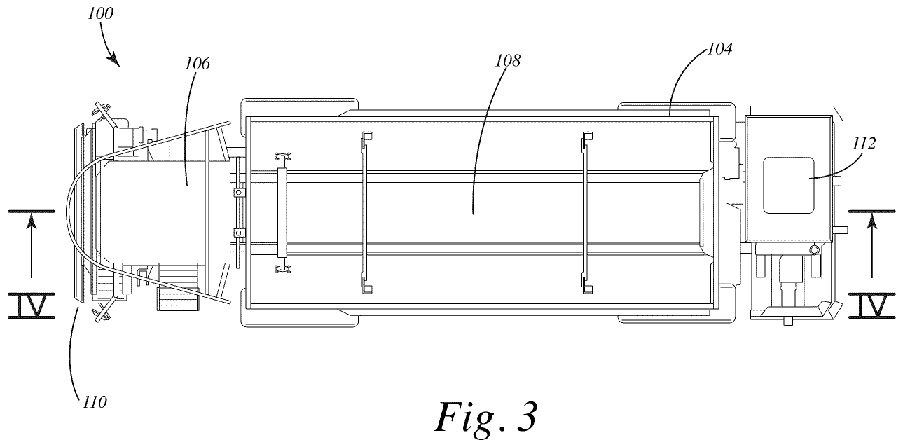

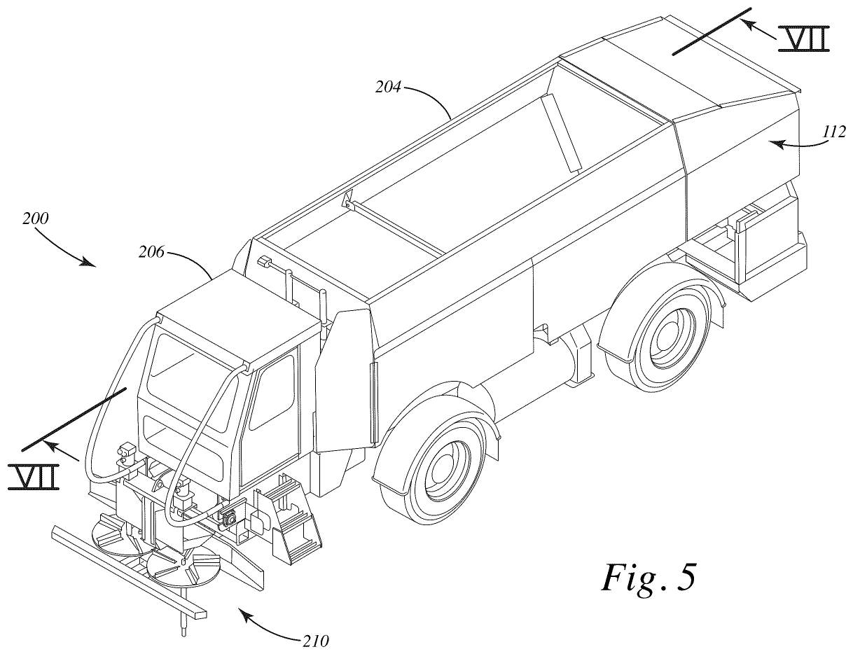

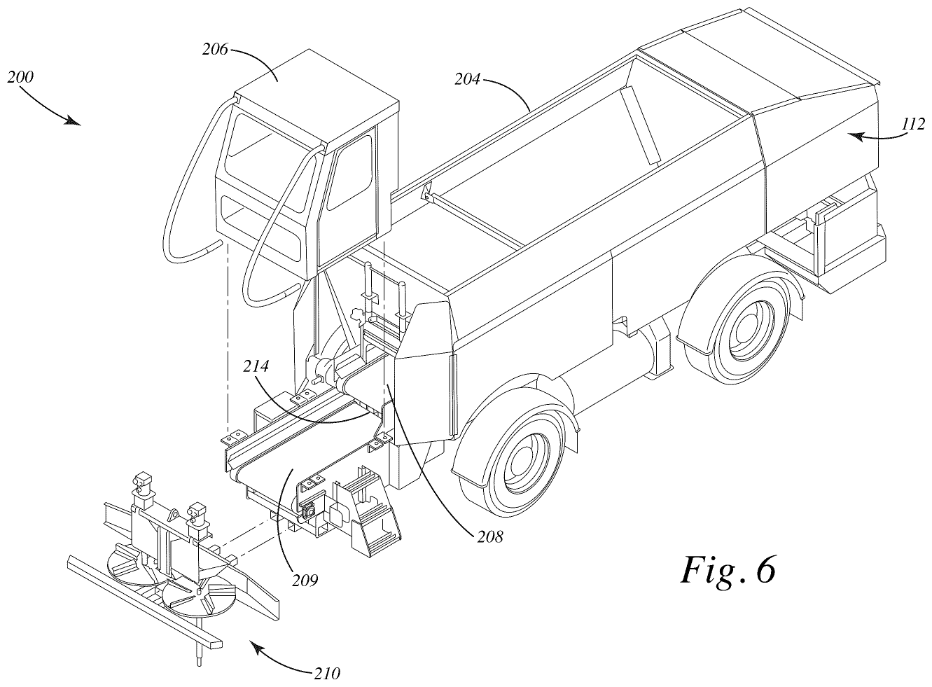

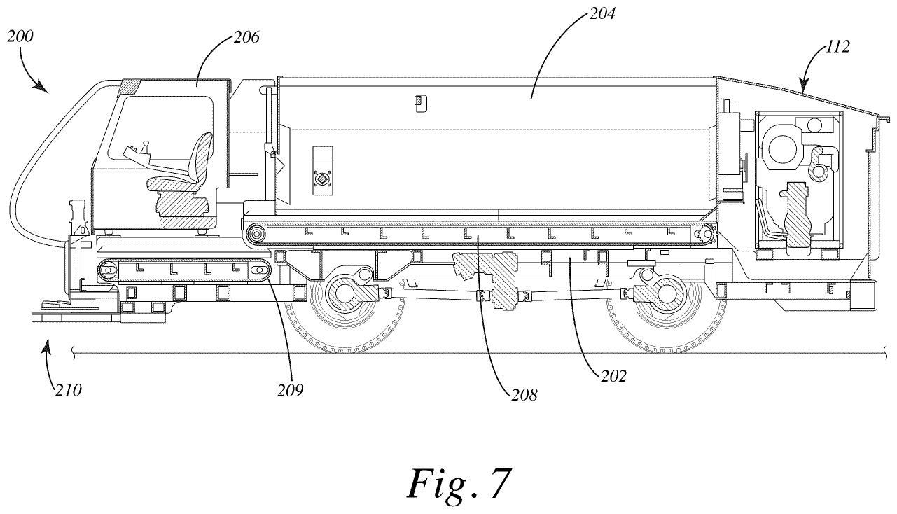

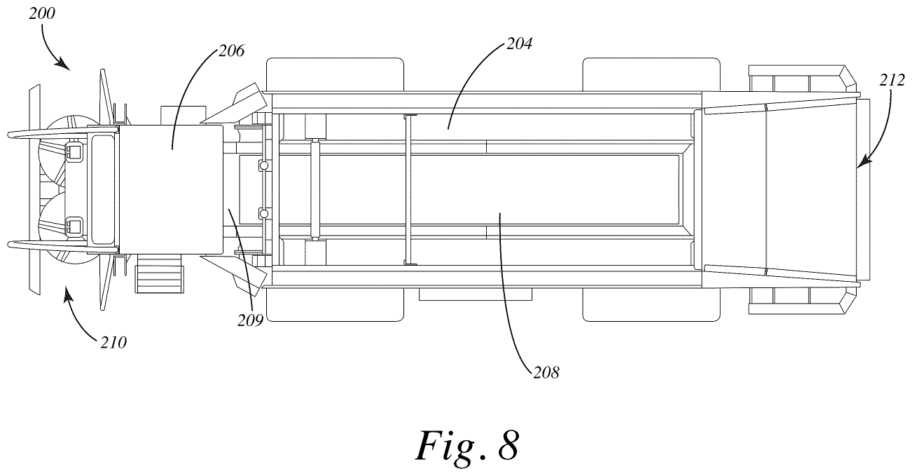

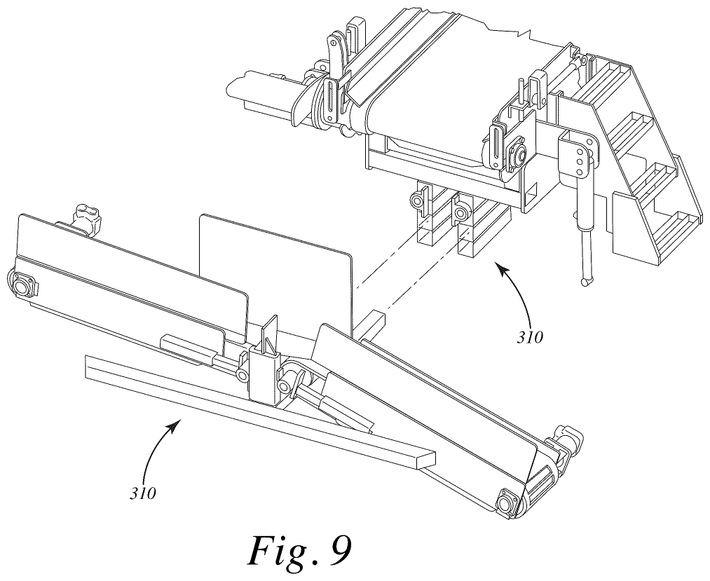

The present disclosure relates to self-propelled front discharge nutrient spreading vehicles with cabs designed to enhance the efficiency and precision of nutrient (e.g., mulch, compost, or granular fertilizer) application in agricultural settings. FIGS. 1-4 illustrate one embodiment that utilizes a single under-cab nutrient delivery conveyor system to deliver nutrients from a nutrient hopper to a nutrient spreader mounted at the front of the vehicle. FIGS. 5-8 illustrate an alternative embodiment that utilizes a cascade or hand-off conveyor system to facilitate lower mounting of the cab that provides lower overall clearance for the vehicle. In this embodiment, a feeding conveyor transfers nutrients to an under-cab receiving conveyor, which delivers the nutrients to the front-mounted spreader.

In certain embodiments designed for enhanced versatility, the drive chassis can be equipped with a nutrient spreader mount configured to accept a variety of interchangeable nutrient spreaders. This allows for the adaptation of the nutrient spreading vehicle to spread different types of nutrients and/or to spread nutrients in different ways (e.g., single conveyor, dual conveyor, dual spinner), catering to a wide range of agricultural demands. Furthermore, it facilitates the vehicle's capability to perform diverse nutrient distribution operations, making it well suited for a comprehensive array of nutrient spreading tasks. By accommodating different nutrient spreaders, the nutrient spreading vehicle can be precisely configured for the efficient dispersal of specific nutrients, tailored to the unique demands of different crops and soil conditions.

The nutrient spreading vehicles of the present disclosure are generally large-scale. For example, the general overall length of the nutrient spreading vehicles can be between 20+ feet in length, 8+ feet tall, and 90+ inches wide. Alternative embodiments can be larger or smaller depending on the application.

Referring to FIGS. 1-4, the self-propelled front discharge nutrient spreading vehicle 100 generally includes a drive chassis 102, nutrient hopper 104, center-mounted cab 106, nutrient delivery conveyor system 108, and a nutrient spreader 110. Due to the nutrient spreader 110 being mounted toward the front of the vehicle and the conveyor system transporting the nutrients from the hopper underneath the center-mounted cab to the nutrient spreader, the operator has an improved view of the nutrient spreading process, which provides enhanced control and precision. For example, should the nutrients become clogged anywhere along the path, the front discharge of nutrients slowing or stopping will be immediately apparent to the operator and allow the operator to address the issue quickly unlike in rear-spreaders where a clog could easily go unnoticed for an extended period of time.

The drive chassis 102 generally forms the base framework of the vehicle, and can support components such as an engine, wheels, and transmission. Such components are not the focus of the disclosure and therefore will not be discussed in detail for the sake of brevity. That said, in general the drive chassis 102 provides structural support and is designed to handle the stresses of agricultural equipment operation, especially when the hopper 104 is loaded with nutrients for dispersal. It can support various components for facilitating steering and mobility, enabling the vehicle to traverse various terrain, such as fields, orchards, or other agricultural terrain. In the current embodiment, a hydraulic system 112 is mounted to the drive chassis 102 to facilitate movement and operation. That is, hydraulic fluid under pressure can transmit power to provide various functions, such as spreader operation, conveyor system operation, steering, driving, and braking. The hydraulic system 112 can include a pump driven by an engine (e.g., a 160 hp engine) that circulates hydraulic fluid under pressure to various hydraulic motors and cylinders throughout the vehicle, which can in turn convert the fluid pressure into mechanical force, which can be controlled according to various control systems, such as a drive control system and a nutrient spreader control system.

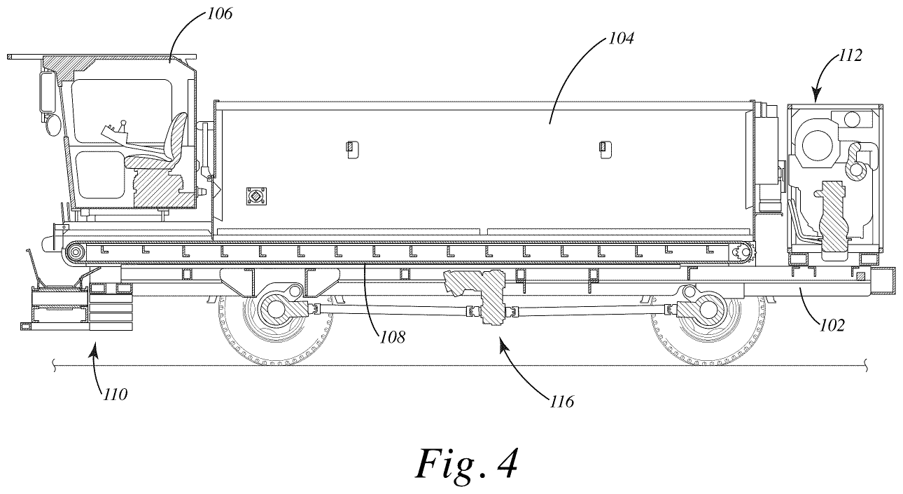

Perhaps as best shown in the sectional view of FIG. 4, a hydrostatic drive system 116 can be mounted to the drive chassis. A hydrostatic drive system, as regularly used in agricultural vehicles for field or orchard work, is a form of transmission that utilizes hydraulic fluid under pressure to transmit power from the engine to the drive wheels. It generally includes a hydraulic pump connected to the engine, and one or more hydraulic motors that are connected to the drive wheels. When the operator controls the vehicle, the pump adjusts the flow of hydraulic fluid to the motors, which in turn changes the speed and direction of the vehicle.

The hydrostatic drive can provide a range of speeds, allowing for precise control of the vehicle's pace without the need for shifting gears. Additionally, hydrostatic drives can deliver high torque at low speeds, which can be beneficial for heavy-duty tasks in challenging terrain or under heavy loads. The ease of controlling speed and direction enhances maneuverability among crops and trees, reducing the risk of damage to the plants and improving the efficiency of various agricultural tasks. In the current embodiment, the hydrostatic drive provides multiple steering modes that the operator can select between, two-wheel and four-wheel steering. While the current embodiments utilize, hydrostatic drive, or essentially any other type of drive system could replace or supplement the hydrostatic drive of the current embodiments.

The nutrient hopper 104 is a large container mounted on the drive chassis 102 for storing nutrients (like fertilizers or manure) to be spread. The hopper facilitates storing and the controlled release of nutrients. The hopper generally has a funnel or pyramidal form, allowing the nutrients loaded into the hopper to naturally flow downwards toward the base of the hopper due to gravity. The base of the hopper can integrate a conveyor system, which could be a belt, screw, chain or essentially any other type of conveyor system, depending on the application. In the current embodiment depicted in FIGS. 1-4, the nutrient delivery conveyor 108 is incorporated at the bottom of the hopper, forming its base and also extends past the wall of the conveyor under the vehicle cab. This configuration provides efficient storage, transport, and controlled discharge of nutrients stored in the hopper.

Primarily, the conveyor 108 facilitates the smooth and continuous extraction of nutrients from the bottom of the hopper, ensuring a regulated flow to the spreader mounted toward the front of the vehicle. This setup is particularly beneficial in agricultural settings, where precise dosing, timing, and distribution of nutrients provide improved efficiency and quality control. The controlled transport via the conveyor also facilitates more uniform discharge from the nutrient spreader, which can provide benefits to both crop growth and yield. The specific features of the hopper and conveyor system can be tailored to the characteristics of the nutrients being handled—such as its abrasiveness, moisture content, and particle size—to reduce blockages and wear, enhancing the vehicle spreader's longevity and reliability.

To enhance functionality and ensure precise control of nutrient flow, the hopper can include a gate, such as vertical sliding gate 114 that is selectively movable between a closed position where nutrients are kept contained in the hopper and an open position where nutrients can flow out of the hopper under the cabin 106 of the vehicle. This gate 114 facilitates regulation of transporting nutrients on the conveyor out of the hopper, allowing them to seamlessly transition from containment within the hopper 104 to the nutrient spreader 110.

The nutrient delivery conveyor system 108 transports nutrients from the hopper 104 to the spreader 110. Essentially, any type of conveyor system suitable for transporting nutrients can be utilized. In the current embodiment, the conveyor uses a heavy-duty pintle chain and drive sprockets, which provide long service life and require low maintenance. As perhaps best shown in FIG. 1, there is sufficient space for nutrients to travel on the conveyor under the center-mounted cab. Further because the conveyor is routed through the front of the hopper under the cab, and the nutrients are discharged out the front of the vehicle, the operator can easily see if there is a jam or if the nutrient delivery from the hopper has slowed. The conveyor system 108 interfaces with the spreader, which is responsible for the final distribution of the nutrients over the crop area. The spreader's effectiveness is enhanced by the steady and controlled flow of nutrients supplied by the conveyor system.

The center-mounted cab 106 is the portion of the nutrient spreading vehicle 100 where the operator controls and monitors the vehicle's functions. Being center-mounted above the conveyor 108 offers the operator a panoramic view through the cab windows, enhancing visibility and precision in nutrient spreading. The cab contains the vehicle's controls, including steering, speed regulation, and the operation of the nutrient spreading system. The cab is designed for operator comfort, safety, and can optionally be equipped with various ergonomic features. In some embodiments, the cab features high grade components for long service life with no controls on the floor to reduce the chances of damage by debris. In some embodiments, the cab can be mounted to one side or the other. That is, in some embodiments, the cab can be mounted off-center while still providing the operator enhanced visibility and precision in nutrient spreading using the front discharge nutrient spreading system.

The nutrient spreader 110 in the current embodiment is a single reversible cross-conveyor that can distribute and discharge nutrients to one side of the vehicle or the other depending on the direction in which the conveyor is operated. The nutrient spreader 110 can be permanently mounted or be removably mounted in embodiments that accommodate selectively removable spreading attachments. For example, a dual conveyor spreader, dual spinning disk spreader, paddle spreader, or essentially any other type of nutrient spreader can be permanently or selectively interchangeably mounted and used for front and/or side discharge of nutrients from the vehicle. The front-mounted nutrient spreader can be controlled by an on-board control system. The vehicle cabin can include a user interface to adjust operation of the front-mounted nutrient spreader. For example, the control system associated with the front-mounted nutrient spreader can have adjustable parameters stored in memory to control the spread width, spread rate, and other characteristics depending on the application, the type of nutrient being applied, or other factors.

Combined control and operation of the conveyor system 108 and nutrient spreader 110 can accommodate different nutrient spreading applications. The operator can independently control the speeds of the main conveyor 108 and the nutrient spreader's cross conveyor (or other spreader system) to accommodate different nutrient spreading applications. These systems can be adjusted dynamically during operation with a user interface inside the cab, e.g., one or more dials that independently or interdependently control the speed of each.

Referring to FIGS. 5-8, another embodiment of a self-propelled front discharge nutrient spreading vehicle 200 is depicted. This embodiment generally includes a drive chassis 202, nutrient hopper 204, center-mounted cab 206, nutrient delivery conveyor system 208, 209 and a nutrient spreader 210. In this embodiment, the nutrient delivery conveyor system is a hand-off style conveyor system that includes two cooperating conveyors, a feeding conveyor 208 and a receiving conveyor 209.

The feeding conveyor 208 of FIGS. 5-8 forms the bottom of the hopper 204 just as in the previous embodiment, except that instead of extending from the hopper all the way to the nutrient spreader, the feeding conveyor 208 extends to just past the vertical gate 214. The receiving conveyor is mounted lower and is positioned to receive the nutrients that fall off the end of the feeding conveyor 208. From there, the receiving conveyor 209 transports the nutrients under the center-mounted cab 206 and delivers the nutrients to the nutrient spreader 210 mounted toward the front of the vehicle spreader 200. This hand-off configuration allows the center-mounted cab to be mounted substantially lower. Perhaps as best shown in FIG. 5, the center-mounted cab 206 can be mounted such that its height generally aligns with the height of the hopper. This allows the vehicle spreader 200 to have a lower overall height profile facilitating passage through areas with lower overhead clearance.

The hopper 204, drive chassis 202, and its supported drive components can generally be the same as in the FIGS. 1-4 embodiment. This embodiment of FIGS. 5-8 is further enhanced by the integration of additional protective elements. For example, angled side shields 218 cover the interstitial spaces between the conveyors 208, 209 of the hand-off conveyor system. Further, protective housing 212 encases the engine compartment at the rear, providing an elevated level of protection against environmental elements and operational debris. Additional, different or fewer of such protective components can be included in any of the embodiments of the current disclosure.

These enhancements not only contribute to the robustness and longevity of the machinery but also refine its operational efficiency by safeguarding critical components. Due to the nutrient spreader 210 being mounted toward the front of the vehicle and the conveyor system transporting the nutrients from the hopper underneath the center-mounted cab to the nutrient spreader, the operator has an improved view of the nutrient spreading process, which provides enhanced control and precision. For example, should the nutrients become clogged anywhere along the path, the front discharge of nutrients slowing or stopping will be immediately apparent to the operator and allow the operator to address the issue quickly unlike in rear-spreaders where a clog could easily go unnoticed for an extended period of time.

The dual spinner 210 can facilitate achieving high precision fertilization. The dual spinner nutrient spreader can provide more even distribution, for example to orchard trees and plants, ensuring enhanced growth and production.

The conveyor systems 108, 208 of the present disclosure can be controlled by an on-board control system. The vehicle cabin can include a user interface to adjust various parameters stored in memory of the control system to adjust operation of the conveyor system. For example, the user interface can include a dial to control the speed of the conveyor belt(s) of the conveyor system. The control system can also be configured with adjustable parameters to tune the rate of nutrient transport dynamically based on sensor inputs, such as varying vehicle speed, spread speed, or other senor inputs.

Referring to FIG. 9, an exemplary nutrient spreader mount 300 is depicted. The nutrient spreader mount 311 is configured to accept a wide variety of interchangeable nutrient spreaders, such as the single cross-conveyor nutrient spreader 110 in FIGS. 1-4, the dual spinner nutrient spreader 210 depicted in FIGS. 5-8, or the dual cross conveyor nutrient spreader 310 depicted in FIG. 9. A control system can be provided that can communicate with and control whichever nutrient spreader is mounted to the front of the nutrient spreading vehicle. The control system can have adjustable settings to control the spread characteristics of that specific spreader depending on the application, the type of nutrient being applied, associated parameters, and other factors. For example, the dual conveyors of the dual-conveyor nutrient spreader 310 can be individually tiltable to provide a precise angle for nutrient distribution and belt speeds can be individually adjustable. In some configurations, the dual conveyors can be configured to simultaneously spread nutrients to both sides of the vehicle simultaneously. In other configurations, the dual conveyors can be configured to operate in the same direction to spread nutrients to one side of the vehicle or the other.

The mount 311 allows for the adaptation of the nutrient spreading vehicle to spread different types of nutrients and/or to spread nutrients in different ways. The mount 311 can include multiple different mount locations to accommodate a range of options for offsetting the nutrient spreader mounted position vertically and/or laterally. Different mounting locations can be selectively chosen by the operator depending on the particular situation and demands of the nutrient spreading operation. By accommodating different nutrient spreaders, the nutrient spreading vehicle can be precisely configured for the efficient dispersal of specific nutrients, tailored to the unique demands of different crops and soil conditions.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

Reference throughout this specification to “a current embodiment” or “an embodiment” or “alternative embodiment” means that a particular feature, structure, or characteristic described in connection with the embodiment is included in at least one embodiment herein. Accordingly, the appearance of the phrases “in one embodiment” or “in an embodiment” or “in an alternative embodiment” in various places throughout this specification are not necessarily all referring to the same embodiment. Furthermore, the particular features, structures, or characteristics may be combined in any suitable manner in one or more embodiments.

The embodiments of the invention in which an exclusive property or privilege is claimed are defined as follows:

1. A large-scale self-propelled front discharge nutrient spreading vehicle comprising:
a drive chassis supporting an engine, wheels, and a transmission, which facilitates self-propelled movement of the nutrient spreading vehicle;
a nutrient hopper supported by the drive chassis, the nutrient hopper being configured to store nutrients;
a front-mounted nutrient spreader supported by the drive chassis, the front-mounted nutrient spreader configured to receive nutrients and regulate at least one of front or side discharge of received nutrients during a nutrient distribution operation;
a conveyor system supported by the drive chassis, the conveyor system operationally connected to the nutrient hopper, wherein the conveyor system is configured to transport nutrients from the nutrient hopper to the front-mounted nutrient spreader;
a vehicle cabin supported by the drive chassis, wherein the vehicle cabin is mounted above the conveyor system and configured to provide an operator within the vehicle cabin a direct line of sight to nutrients discharged from the front-mounted nutrient spreader during a nutrient distribution operation; and
whereby the mount location of the vehicle cabin facilitates enhanced control and precision of nutrient distribution operations by allowing the operator to monitor the flow of nutrients directly while driving the large-scale self-propelled nutrient spreading vehicle.

2. The large-scale self-propelled nutrient spreader of claim 1, wherein the front-mounted nutrient spreader is controlled by a control system, wherein the vehicle cabin includes a user interface to adjust operation of the front-mounted nutrient spreader.

3. The large-scale self-propelled nutrient spreader of claim 2, wherein the control system includes adjustable parameters stored in memory to control the spread characteristics of the front-mounted nutrient spreader.

4. The large-scale self-propelled nutrient spreader of claim 1, wherein the conveyor system is controlled by a control system, wherein the vehicle cabin includes a user interface to adjust operation of the conveyor system.

5. The large-scale self-propelled nutrient spreader of claim 4, wherein the control system includes adjustable parameters to tune the rate of nutrient transport to the front-mounted nutrient spreader dynamically based on varying vehicle speed.

6. The large-scale self-propelled nutrient spreader of claim 4, wherein the control system includes adjustable parameters to tune the rate of nutrient transport to the front-mounted nutrient spreader dynamically based on front-mounted nutrient spreader speed.

7. The large-scale self-propelled nutrient spreader of claim 1, including a nutrient spreader mount configured to accept a plurality of interchangeable nutrient spreaders.

8. The large-scale self-propelled nutrient spreader of claim 7, wherein the plurality of interchangeable nutrient spreaders include a single cross-conveyor nutrient spreader, a dual spinner nutrient spreader, and a dual cross-conveyor nutrient spreader.

9. The large-scale self-propelled nutrient spreader of claim 1, wherein the conveyor system is a hand-off conveyor system including a feeding conveyor and a receiving conveyor, wherein the receiving conveyor is mounted under the vehicle cabin and the feeding conveyor is integrated as the floor of the hopper such that the feeding conveyor transports nutrients from the hopper to the receiving conveyor, which in turn delivers the nutrients under the vehicle cabin and to the front-mounted nutrient spreader.

10. The large-scale self-propelled nutrient spreader of claim 1, wherein the conveyor system includes a single conveyor integrated as the floor of the hopper that extends out of the hopper under the vehicle cabin to above the front-mounted nutrient spreader.

11. A method for operating a large-scale self-propelled front discharge nutrient spreading vehicle, the method comprising:
loading a nutrient hopper of the large-scale self-propelled front discharge nutrient spreading vehicle with nutrients;
conveying, under a center-mounted vehicle cabin, the nutrients from the nutrient hopper with a conveyor system operationally connected to the nutrient hopper;
receiving, at a front-mounted nutrient spreader, nutrients from the conveyor system;
discharging the received nutrients with the front-mounted nutrient spreader during a nutrient distribution operation;
monitoring the flow of nutrients, wherein the monitoring includes observing the nutrient distribution operation with a direct line of sight from the center-mounted vehicle cabin.

12. The method for operating a large-scale self-propelled front discharge nutrient spreading vehicle of claim 11, including adjusting, with an in-cabin user interface, parameters in memory of a control system to control spread characteristics of the front-mounted nutrient spreader.

13. The method for operating a large-scale self-propelled front discharge nutrient spreading vehicle of claim 11, including adjusting, with an in-cabin user interface, parameters in memory of a control system to control operation of the conveyor system.

14. The method for operating a large-scale self-propelled front discharge nutrient spreading vehicle of claim 11, including adjusting parameters, with a control system, to automatically control a rate of nutrient transport to the front-mounted nutrient spreader dynamically based on vehicle speed.

15. The method for operating a large-scale self-propelled front discharge nutrient spreading vehicle of claim 11, including adjusting parameters, with a control system, to automatically control a rate of nutrient transport to the front-mounted nutrient spreader dynamically based on front-mounted nutrient spreader speed.

16. The method for operating a large-scale self-propelled front discharge nutrient spreading vehicle of claim 11, including selectively removing the nutrient spreader from a nutrient spreader mount configured to accept a plurality of interchangeable nutrient spreaders and selectively installing a different nutrient spreader on the nutrient spreader mount.

17. The method for operating a large-scale self-propelled front discharge nutrient spreading vehicle of claim 16, wherein the plurality of interchangeable nutrient spreaders include a single cross-conveyor nutrient spreader, a dual spinner nutrient spreader, and a dual cross-conveyor nutrient spreader.

18. The method for operating a large-scale self-propelled front discharge nutrient spreading vehicle of claim 11, including operating a hopper gate to permit release of or prevent flow of nutrients out of the hopper.

19. The method for operating a large-scale self-propelled front discharge nutrient spreading vehicle of claim 11, wherein the conveyor system is a hand-off conveyor system including a feeding conveyor and a receiving conveyor, wherein the receiving conveyor is mounted under the vehicle cabin and the feeding conveyor is integrated as the floor of the hopper such that the feeding conveyor transports nutrients from the hopper to the receiving conveyor, which in turn delivers the nutrients under the vehicle cabin and to the front-mounted nutrient spreader.

20. The method for operating a large-scale self-propelled front discharge nutrient spreading vehicle of claim 11, wherein the conveyor system includes a single conveyor integrated as the floor of the hopper that extends out of the hopper under the vehicle cabin to above the front-mounted nutrient spreader.
